(19) United States
(12) Patent Application Publication
(10) Pub. No.: US 2020/0097990 A1
(43) Pub. Date: Mar. 26, 2020

(54) DIGITAL CONTENT CREATION AND DELIVERY WITH ADVERTISING CONTENT

(71) Applicant: Mars Callahan, Henderson, NV (US)

(72) Inventor: Mars Callahan, Henderson, NV (US)

(21) Appl. No.: 16/576,763

(22) Filed: Sep. 19, 2019

Related U.S. Application Data
(60) Provisional application No. 62/734,045, filed on Sep. 20, 2018.

(51) Int. Cl. G06Q 30/02; G06Q 30/06; H04N 21/472; H04N 21/441

(52) U.S. Cl. CPC G06Q 30/0217; G06Q 30/0245; H04N 21/441; H04N 21/472; G06Q 30/0609

(57) ABSTRACT

Selection and playing of digital media with an advertisement or product placement by a user that provides a reward to the viewer upon completion of a test that verifies viewing of the products and the viewer's identity.

### RELATED APPLICATION

This application claims priority to U.S. Provisional Patent Application, Ser. No. 62/734,045, titled “Digital Content Creation and Delivery with Advertising Content,” filed on Sep. 20, 2018, which is incorporated herein by reference in its entirety.

### TECHNICAL FIELD

The present invention relates generally to advertising and more particularly to consumer recognition of viewed product placement.

### BACKGROUND

Traditional advertising practices have become dated and less reliable with the transition from print movies, television shows, traditional media to digital media. With the creation of digital media, digital video recorders (DVRs), and streaming services, advertisements are being skipped or otherwise ignored by content viewers. Attempts have been made to strategically place products in films and television shows as they are being produced and/or recorded. But, verification of the recognition of the placed product is lacking.

The product's manufacturers typically pay for their products to be placed into the movie or television show. Such product placement results in consumers viewing the placed product, but there is not an ability to verify the product was seen and that the consumer remembered or recognized the placed product. Generally, consumers do not directly obtain benefits from watching or listening to advertisements and such content is often perceived to be of little or no value to them. Consequently, if advertisements are run before, during, or after digital content is played, there is a good chance that a viewing consumer will ignore the advertisement or fast-forward through it if the viewing device enables the consumer to do so.

A known approach for determining if the content has been viewed is to count clicks or click through. But, there is no determination of a consumer's memory of the product or recognition of the actual advertisement or product placement. Other attempts at determining if an advertisement or product placement has been viewed are to offer a coupon or coupon code to consumers who view the advertisement or product placement. But, typically no verification of the user who viewed the product is the person using the coupon code or coupon occurs.

Another known approach in the art of verification of viewing content, such as an educational course, involves testing the person is present during viewing by periodically stopping the media unit and requiring the viewer to start it again or offering a test to verify viewing of the complete media. But such approaches are disruptive to watching motion pictures and shows. Further, simply knowing if someone has viewed the media, movie, or show fails to provide feedback to companies that invested in product placement.

What is needed is an approach for the creation and presentation of content that enables products to be advertised in association with content or in the content and verification of the consumer viewing and comprehending the advertisement and or product placement that also is not disruptive to the viewer's viewing experience of the content.

### SUMMARY

Content is created that has product placement in one or more positions in the content. An online/digital test with a plurality of questions associated with product placement is created. A consumer views the content and upon finishing viewing the content is presented with the test. The device used to view the content may be the device that displayed the test, or a separate device, such as a smart device. The test is accessed via a client-server network or a cloud implementation. The viewer is also verified to be the user/owner of the account associated with the viewing and completed test. An advantage of the disclosed approaches is the multiple opportunities that are created to view placed products in the viewing/testing experience.

Another advantage to the disclosed approach is the reward system associated with the placed products. Upon completion of the test, coupons or discounts for the placed items are provided to the viewer. A payment reward is also available that may be tracked using a blockchain cryptocurrency or other cryptocurrency value storage means.

Other devices, apparatus, systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is an illustration of a processor-controlled device 102 that executes instructions that result in an example implementation of the invention.

FIG. 2 is an illustration of user interface 152 (home page) of FIG. 1 in accordance with an example implementation.

FIG. 3 is an illustration of the Indie Films sub-page 240 of FIG. 2 in accordance with an example implementation of the invention.

FIG. 4 is an illustration of the signup sub-page 402 accessed via the login button 204 of FIG. 2 in accordance with an example implementation of the invention.

FIG. 5 is an illustration of the media player 137 of FIG. 1 in accordance with an example implementation of the invention.

FIG. 6 is an illustration of product placement verification window 602 in accordance with an example implementation of the invention.

FIG. 7 is an illustration of product placement verification window 602 of FIG. 6 with rewards in accordance with an example implementation of the invention.

FIG. 8 is an illustration of a transition sub-page 802 in accordance with an example implementation of the invention.

FIG. 9 is an illustration of the cash-out sub-page 902 accessed by button 814 of FIG. 8 in accordance with an example implementation of the invention.

FIG. 10 is an illustration of a scheduling sub-page 1002 accessed by the scheduling pulldown menu 204 of FIG. 2 in accordance with an example implementation of the invention.

FIG. 11 is an illustration of a flow diagram 1100 of the SELFMADE approach is depicted in accordance with an example implementation.

### DETAILED DESCRIPTION

As used herein, an approach for digital content created with consumer product advertisement placed in the digital content or associated with the performance or playing of the digital content is described using an example implementation. In addition to the digital content, test questions are created that are used to verify the placed product was viewed during the playing of the digital content and a reward is provided for correctly answering the test questions.

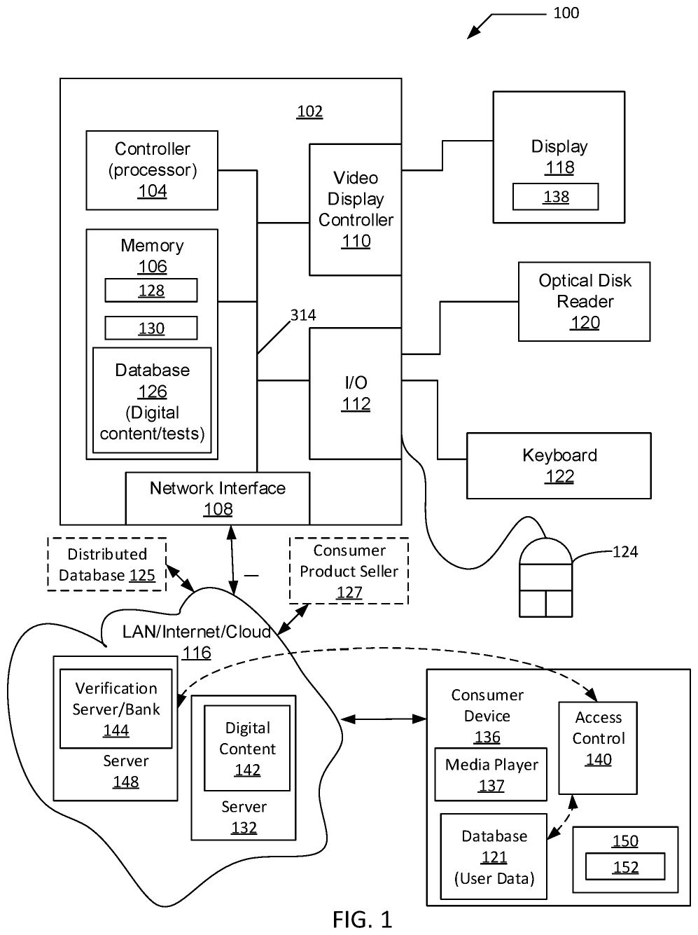

Turning to FIG. 1, an illustration 100 of a processor-controlled device 102 that is able to access a database 126 associated with the storage and delivery of content with associated product placement and/or associated advertising along with creation and delivery of a test to verify comprehension/viewing of the promoted consumer product in accordance with an example implementation of the invention. The processor-controlled device 102 (SELFMADE server) may be a server implementing or hosting the “SELFMADE” system and have the control, system, and security portions of control for the depicted example implementation. In other implementations, the processor control device may be combined with other portions of the system or distributed among other devices.

The processor control device may have at least one controller 104 (processor) coupled to a memory 106, network interface 108, video controller 110, and input/output (I/O) interface 112 by address/data bus 114. The network interface 108 may couple the processor-controlled device 102 to a network, such as one or more local area networks (LANs)/internet/cloud 116 and servers, such as server 132 located in the cloud, and BAS 136. The connection to the LANs/internet/cloud 116 may be wired or wireless (such as IEEE 802.11g or 802.11n standards). The video controller 110 may be coupled to one or more displays, such as display 118. The display is typically a digital video display, such as HD television or VGA computer display. The I/O interface 112 may be coupled to a keyboard 122, optical disk reader 120, and mouse 124.

The controller 104 executes instructions that may be stored in memory 106 that facilitate the operation of the processor-controlled device 102. The memory 106 may be logically or physically split into an operational memory 128 that provide operational instructions for the processor-controlled device 102 and an application memory 130. The memory 106 may have one or more databases, such as database 126 stored therein for access by the application when executed by the controller 104 stored in application memory 130. In other implementations, the application memory 130 may be dedicated to one application. An initial naming convention may initially be loaded into application memory 130, where the initial naming definition file is a typical approach to naming different elements in the database 126 and contains partial names, such as suffixes and/or strings of text.

The database 126 may be a portion of a larger database, distributed database 125, or simply data written or read from the distributed database 125 and otherwise copied into memory 106 by the controller 104. In other implementations, the database 125 may be read in real-time or be located in the cloud or an external network. In yet other implementations, the database may have been previously stored in the memory or disk storage of server 132. The database 125 contains data elements, user data, digital content location data, and consumer product information, including reward amounts, associated test information, loyalty program information, in addition to data required to support the approach of the example implementation.

The consumer device 136, such as a computer, tablet, smartphone, CHROMECAST, APPLETV, smart television, or smart device has a SELFMADE access control 140 that enables secure access to server 102. The consumer device 136 may have a media player 137. The media player 137 that interacts with the access control 140 and is able to at least play digital content 142 stored on server 142 and or otherwise referenced by the SELFMADE server 102. In other implementations, the media player 137 may be a web browser plugin. In other implementations, the media player 137 may be a common media player. A display 150 enables the played media from the media player 137 to be displayed. Similarly, the display 150 may display a graphical user interface 152 that enables data to be entered into the consumer device via a touchscreen. In other implementations, an additional interface may enable keyboards, mice, trackballs to interface with the graphical user interface 152. User data may be stored in database 121 that contains user data required to access the SELFMADE server 102 and the digital content 142 contained in the digital content server 132. The digital content server 132 with digital content 142 in other implementations may be internal to the SELFMADE server 102. In yet other implementations, the digital content 142 may be implemented with other remote devices.

The application in application memory 130 is executed by the controller 104 and results in a graphical user interface 138 appearing on display 118 for management and configuration of the SELFMADE server 102. The management and configuration of the SELFMADE server 102 enable association of the digital content 142 that may be associated with product placement from a consumer product seller 127 or advertisement produced by the consumer product seller 127.

Upon logging into and verification of the user of the SELFMADE server 102 via the access control 140 of the consumer device 126 and the verification server/bank server 144 that may reside on server 148. The user may access and view digital content 142 (that resides on one or more digital content servers, such as digital content server 132), view and/or manage their earned credits that may be recorded in the verification server/bank 144 on server 148. In other implementations, the verification server/bank 144 may be collocated with other servers such as digital content server 132 and SELFMADE server 102.

Credits may be earned by the user of the consumer device 136 by viewing digital content 142 on media player 137. The digital content may be video, audio, video games, computer programs, pictures, eBooks, or a combination of the video, audio, video games, computer programs, and pictures. The credits may be awarded upon completion of a test that is associated with the SELFMADE server 102 and the digital content. Such tests may be located on server 102. In other implementations, the test may be located with the digital content 142 on the digital content server 132, or verification server/bank 144 on server 148. In yet other implementations, the tests may be distributed among multiple SELFMADE servers where each server (or a plurality of servers) support a different language of digital content. The credits may be issued upon achieving a predetermined score on a test by the user. In other implementations, credits may be provided for actions, such as viewing the digital media, taking the test, and achieving a predetermined score on a test. It is noted the test is verifying that a promoted product (may also be a service) that is being promoted has been viewed and also acts to reinforce the product in the user's mind.

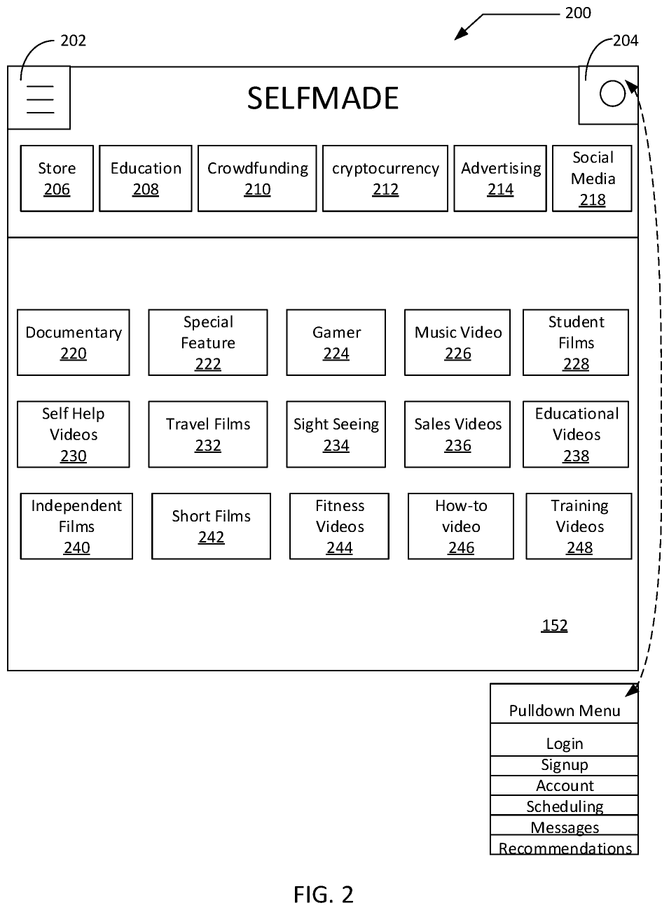

FIG. 2 is an illustration 200 of user interface 152 (home page) of FIG. 1 in accordance with an example implementation. The user interface 152 may be implemented in a graphical user interface system, such as Windows, macOS, Android, to give but a few examples. The user interface (home page) 152 may be implanted in Java, C++, and Python to give but a few examples. The home page presents a window 200 that contains a menu button 202, access button 204, and a plurality of other buttons for accessing other sub-pages 206-218 and media 220-248. A store sub-page button 206 enable users to spend money or cryptocurrency earned by viewing media and tracked in the current implementation with a blockchain. An education sub-page button 208 enables users to access free educational content in the current implementation. In other implementations the educational content may be purchased or a combination of purchased and free educational content may be available. A crowdfunding sub-page button 210 to enable a user to access crowdfunding media production opportunities. A cryptocurrency sub-page button 214 to enable a user to access their cryptocurrency earned by viewing media, trading, or purchasing. An advertising sub-page button 216 that enables people and business to learn about advertising opportunities. A social media sub-menu button 218 that enables a user to access social media accounts for SELFMADE (i.e. TWITTER, FACEBOOK, INSTAGRAIVI). Media buttons 202-248 are links to media that can be played. Some buttons may connect to sub-page of similar types of media, such as Documentary Films 220, Special Features 222, Gamer Videos 224, Music Video 226, Student Films, Self Help Videos 220, Travel Videos 232, Sightseeing Tours 234, Sales/Promotional Videos 236, Educational 238, Independent (Indi) 240, Short Films 242, Fitness Videos 244, How-To Videos 246, and Training Videos 248.

Pulldown menu 204 also enables a user to select “Recommendation” and have the SELFMADE system access the user historic data of previous media accessed, coupons redeemed that is stored in the databases accessed by the system and make recommendations for what media to view. An advantage of such an approach is not only recommending media a user may like, but also promote content having placements of items the user may use coupons or discounts to buy. This increase the value of product placement in media viewed in the SELFMADE system.

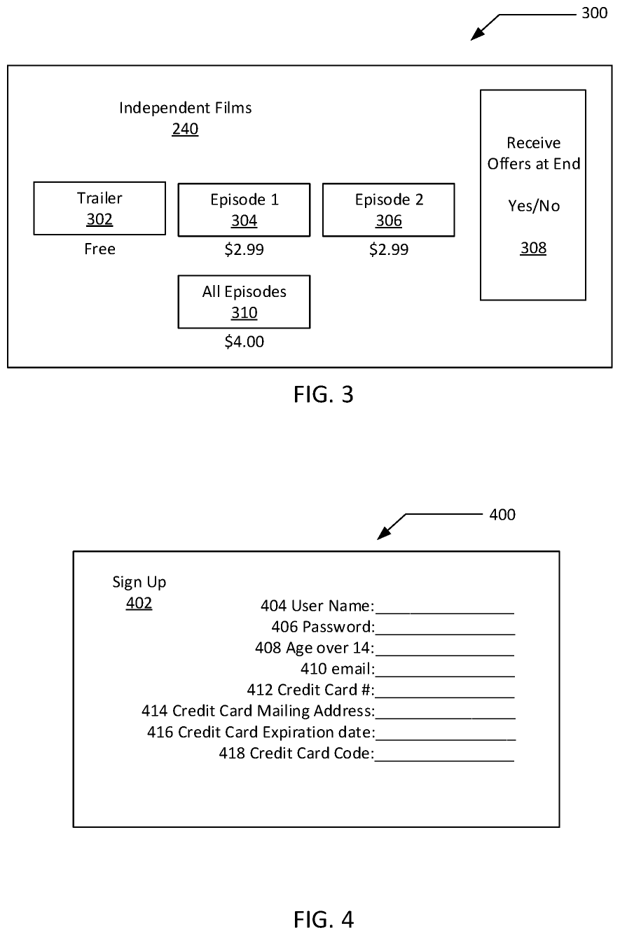

In FIG. 3, an illustration 300 of Independent film sub-page 240 of FIG. 2 is depicted in accordance with an example implementation of the invention. If only one independent film or film series is available, then the user may directly be taken to the sub-page 240. Otherwise, a page showing a number of independent films or independent film series is displayed that when selected results in sub-page 240 being displayed.

On Indie sub-page 240, a trailer button 302 is present that enables a user to play the trailer media for the selected show is displayed. The playing of trailer media will typically be free to entice a person to purchase and view the independent media (film or film series) or an episode of a series. In order to play the media, a media play button 304 is provided for purchasing and playing the selected media episode. If a whole series is desired to be purchased, the all Episodes button 310 may be used. If multiple episodes are available, additional buttons may be available for purchasing and playing additional episodes, such as button 306. Upon purchase of the desired media (charring of a credit card/payment via cryptocurrency) and prior to playing the media, an offer to earn a reward is presented 308. In the current implementation, the offer is to take a short test and earn money/cryptocurrency and discounts are presented. In other implementations, other types of graphical interfaces other than buttons may be employed in the selection and purchase of media such as sliders, pull-down boxes, etc. . . . In yet other implementations prices of the media may be depicted after a selection is made rather being displayed on sub-page 240.

It is noted that in the current implementation, the user needs to be logged in (via selecting the login button 204, FIG. 2 and logging in prior to purchasing. When button 204 is selected, then options to login and signup are available. In order to log in, a user must be registered in the current implementation.

Turning to FIG. 4, an illustration 400 of the signup sub-page 402 accessed via the login button 204 of FIG. 2 is depicted in accordance with an example implementation of the invention. Signup sub-page 402 enables a user to enter a user name 404, password 406, If age is over 14 408, email 410, credit card number 412, credit card mailing address 414, credit card expiration date 416, and credit card code 418. Upon supplying all the signup date, a user is able to log in via the login button 204 and simply enter their user name and password. In other implementations additional information may be requested during signup and additional information may be used or required during login, such as two-factor authentications. In yet other implementation, other websites' login verification may be used when logging into SELFMADE, such as GOOGLE or FACEBOOK.

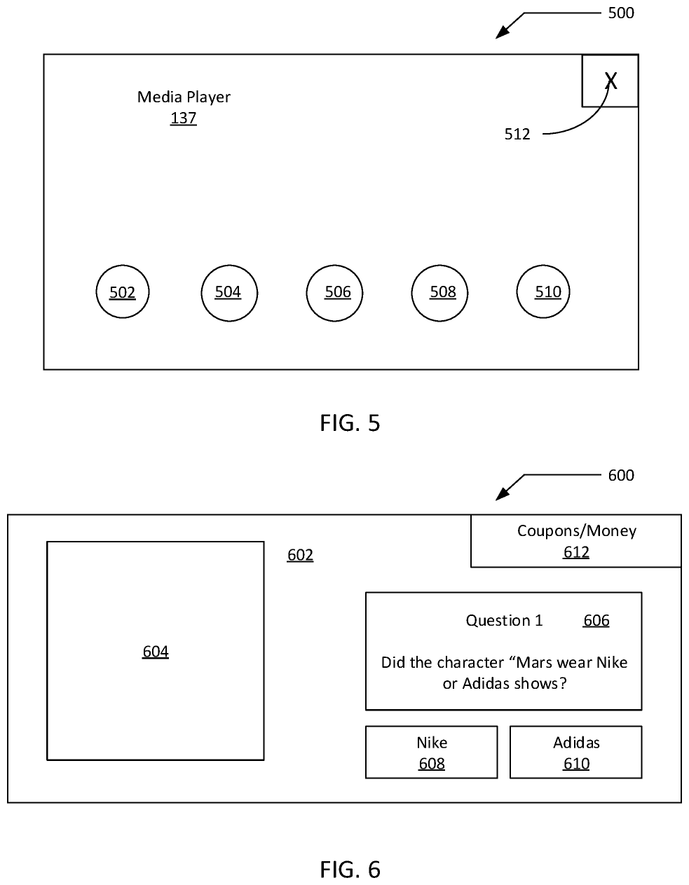

In FIG. 5 an illustration 500 of the media player 137 of FIG. 1 is depicted in accordance with an example implementation of the invention. The media player 137 is able to play digital media files such as audio video interleave (AVI), windows media video (WMV), QUICKTIME (MOV, QT), Matroska (MKV), MP4/MPEG-4, Advanced video coding, high definition (AVCHD), Flash (FLV, SWF), to name but a few. Upon a media file being selected, it is eventually streamed to and played on the media player 137. The media player 137 in the current implementation is configured to play a streaming video configured in a format suited for video streaming, such as F4V files that support H.264, also known as MPEG-4 AVC (Advanced video coding). The video player 137 enables a video or media file being played to be paused 502, stopped 504, play 506, fast forward 508, rewind 510, and shutdown 512. In other implementations, the media files may be encrypted in addition to being formatted. The encryption may be on the streamed data or upon the encoding of the video file into a media file.

Turning to FIG. 6, an illustration 600 of product placement verification window 602 is illustrated in accordance with an example implementation of the invention. The product placement verification window is displayed after the media has been played in response to the user accepting offers 308 of FIG. 3. An image of the product that was placed in the media (movie, video, film, etc. . . . ) is displayed 604 with a question about the item 606 with two or more possible answers 608 and 610. A novel aspect of this approach is the placed product was seen by the user while watching the media and reinforcement of that presented product is then presented in a still image 604 a second time. A third reinforcement of the product occurs when the user must actively identify the product (pushing button 608 in the current implementation). If a wrong product is selected 610, then a message, such as “TRY AGAIN” may be displayed. Additional information may also be displayed, such as number of coupons or amount of money 612 a user has earned

In other implementations, gamification may be employed to promote viewing and rewards, coupons, and/or discounts may be awarded for a predetermined number of concurrent days viewing media on SELFMADE, predetermined number of media purchased in a predetermined time period, inviting or gifting new users, etc.

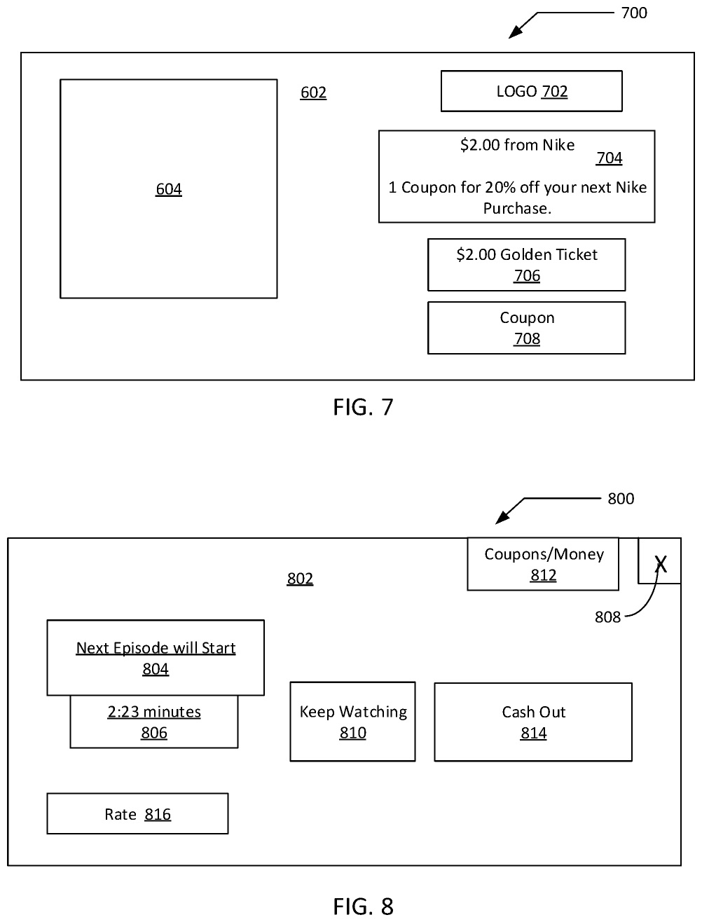

Turning to FIG. 7, an illustration 700 of product placement verification window 602 with rewards 706, 708 is depicted in accordance with an example implementation of the invention. The logo 702 for the placed product is displayed along with a message indicating the reward/payment 704. A further graphical representation of the granting of cryptocurrency or other types of payment for watching the media, a “Golden Ticket” representing the granting or issuing of two dollars to the user in the current example. The logo 702 is another brand reinforcement element along with an e-coupon 708 for the placed product being yet another brand reinforcement. The coupon, if used by the user, enables the e-coupon 708 to be associated with the user and their data. Over time, data associated with the viewing habits and buying habits of user are accumulated and stored in the databases (such as distributed database 125) of the SELFMADE system that can be mined to increase the value of product placements based upon on products, subject matter of the media and user information (sex, age, location, interests, credit history, etc.)

The product placement window 602, displays the next question as described in FIG. 6 and issues a reward as described in FIG. 7. The image of another product that was placed depicted in the product placement window 602 with associated questions and possible answers. The award of cryptocurrency (the Golden Ticket) occurs for each placed item in the current example. In other implementations, it may only occur in the first, last, or at a different time or after a different event. In the current implementation, after five images of products have been presented and questions answered, with awards and coupons issued, a transition sub-window appear.

In FIG. 8, an illustration 800 of a transition sub-page 802 is depicted in accordance with an example implementation of the invention. If a film or video series has been purchased, rather than individual episodes, a next episode message 804 is displayed in the transition dub-page 802 along with a count-down timer 806. In order to exit the transition sub-page 802, the user may select the “X” 808 located in the corner and the current sub-page 802 will close and the home page will be displayed. If a user desires to start watching the next episode immediately, the user can select the keep watching button 810 and the media player 137 of FIG. 5 will start to play the next episode. Other information may be displayed on the transition sub-page 802, such as the number coupons received and value in the users account 812 (cryptocurrency, money, tokens, or other value units that may be awarded). Other options, such as cashing out 814 the value present in their account but selecting the cashing out button 814 on transition sub-page 802.

A “Rate” pulldown button 816 is also present on the transition sub-page 802 to enable the viewer to rate the media that was just viewed. In the current implementation, the Rate pulldown button enables a user to select 1-10, with 1 being bad and 10 being great. The ratings entered by the different users may then be combined, averaged and displayed on the trailer page accessed by trailer button 302 of FIG. 3.

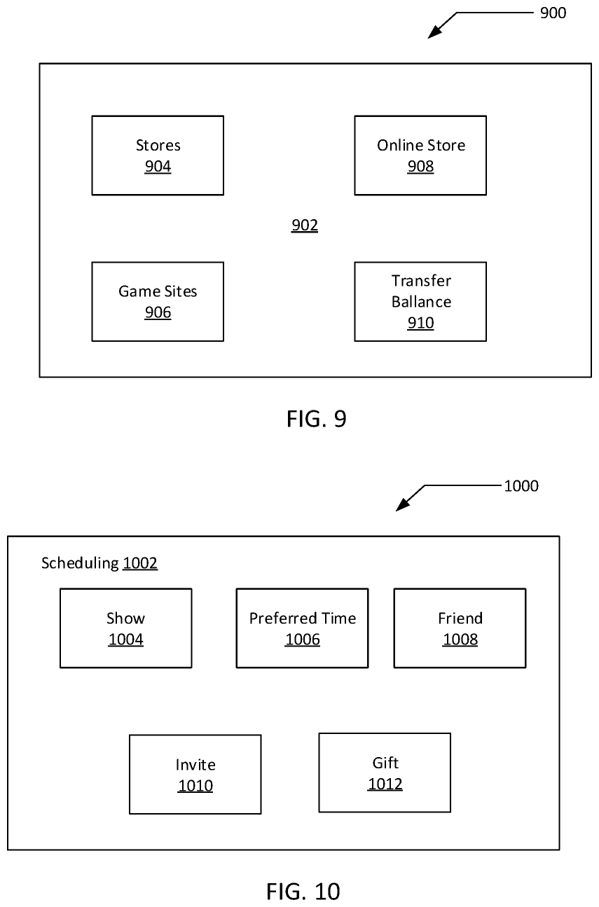

Turning to FIG. 9, an illustration 900 of the cash-out sub-page 902 accessed by button 814 of FIG. 8 is depicted in accordance with an example implementation of the invention. In the cash-out sub-page 902, a button to access store sites 904, game sites 906, an online store 908, and transfer balance 910. If a user selects to shop at third-party stores of brands who placed products in media, then button 904 is selected and a list of links to such stores is provided. The user then can select a third-party store where money or cryptocurrency in the user's account may be spent. The user may access a game site by selecting the game sites button 906, where a list of game sites such as gambling sites where money or cryptocurrency may be spent. An online store button 908 may be present that enables a user may purchase items or shows, invest in crowdsourced media, or buy merchandise on the current SELFMADE site.

In FIG. 10, an illustration 1000 of a scheduling sub-page 1002 accessed by the scheduling pulldown menu 204 of FIG. 2 is depicted in accordance with an example implementation of the invention. A user is able to select a show with a pulldown menu 1004 and a preferred time 1006. This feature is novel because it enables release of movies, videos, series episodes to be scheduled at a time that is most convenient as indicated by the consumer rather than relying on a decision made by a small group of individuals (such as a network executive). As the hype and expectation of an episode can be increased due to the maximization of people able to view it when it is released. Furthermore, the more people schedule to see a movie, film, video or episode the more valuable the product placements in that media will be.

A friend button 1008 may be used to enter a sub-menu to search for and invite friends to a virtual group. Once a friend's virtual group associated with the user is created, individuals (invitees) in it may be invited (with button 1010) to view the media at the same time as the user (inviter). The invites are electronic messages that are delivered within the SELFMADE system and accessed by pulldown menu 204. Confirmation of receipt of the messages is similarly returned to the inviter who can access them via the messages in the pulldown menu 204. In other implementations, electronic mail or texting may be used in addition to messaging or in place of messaging. In the current implementation, the invitees and the inviter will need to each pay for access to the media. In other implementations, a predetermined number of invitees may be able to remotely view on one or more remote devices the media at the same time as the inviter for a single payment. In some implementations, the single payment may be above what a single device would pay.

Additionally, a gift of a movie, video, film, or other content may be gifted to a friend. In one example implementation, the user selects the gift button 1012 and is able select and pay for a media selection for one or more recipient from this list of friends and then have an electronic notice sent by the system to the gift recipients. In other implementations, cellular phone numbers or electronic mail address may be used to identify friends and send invites and gifts to users who are members of SELFMADE and individuals who have not joined SELFMADE, who will then have to join to use their gift. A novel advantage of enabling none users of SELFMADE to receive gifts is current users became marketers by gifting access to media to none users, who are then required to join. The increase in users increases the value of product placements in the media.

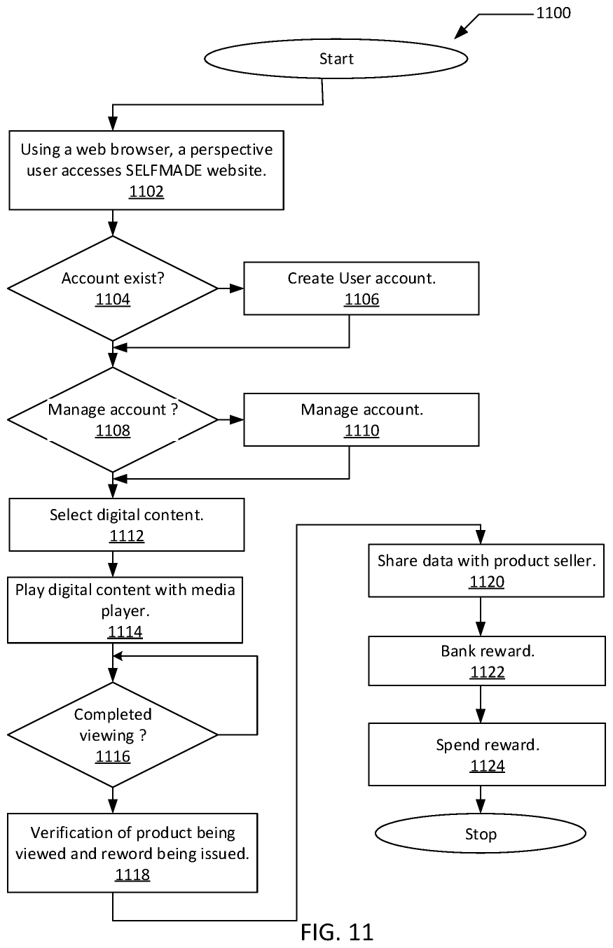

In FIG. 11, a flow diagram 1100 of the SELFMADE approach is depicted in accordance with an example implementation. The SELFMADE implementation may be implemented as a website with a home page where users can log in, create an account, watch streaming or other digital content and get rewarded (e.g. cash and/or coupons). The flow diagram 1100 starts with a perspective user accessing a web browser to access the SELFMADE website in step 1102.

A prospective user arrives at the home page for SELFMADE in step 1102. The home page features the digital content that is able to be streamed or otherwise accessed. On the home page, prospective users will have the ability to view trailers for the shows and other digital content. The prospective user may consider watching as well as discovering what each show will reward them for accessing (watching either a single episode of television or an entire season, listening to podcasts, listening to music, etc. . . . ).

If the prospective user does not have an account in step 1104, they can create an account by selecting a “create an account” button in step 1106. If the prospective user clicks the button that reads “create an account” button then the web browser screen will change and they will be taken to a page where they will be able to create an account in step 1106.

In order to create an account, the user identifies themselves through various standard verification processes and read and agrees to all terms and conditions. In the terms and conditions (and only once the user has been paid by selfmade.com for watching digital content) users must agree to allow their personal and private information to be shared with the companies that are sponsoring selfmade.com and the television shows the user is being paid to watch (commonly called Opt-In). Users must also agree to allow these sponsoring companies to continue to market their products to them in the future.

When creating an account, users fill in all of their pertinent information including name, address, age, gender, email address, create a password, and they are required to answer ten very unique security questions that only the user will know the answers to in the current implementation. In other implementations, additional information or other information may be collected.

The user then has an account that is associated with a bank sub-account that will be referred to as “bank”, which starts with zero credits in it and a coupon sub-account that will be referred to as “coupons”, which ideally will start with a few promotional coupons in it from the SELFMADE web site sponsors. Once an account is fully created then the user can now start earning rewards (e.g. credit, money, and coupons) by watching or listening to the digital content.

Once the account is created or logged into in step 1104, a user can manage their account in step 1108. Managing their account includes changing account information, checking on bank and coupon balances/availability. In step 1112, the user can then click back on the home page button where all the digital content that is available to will appear again and decide which ones they want to access.

It will be stated on the home page that the user will be paid or credited a predetermined amount (such as $100.00) digital content. For example, watching any ten-episode season of any show on its platform and for answering questions (taking a test) and verification of their identity (e.g. answering three security questions correctly) at the end of each episode. Similarly, audio digital content, video games, pictures may also be played in a similar manner.

In the example implementation, if a SELFMADE user watches a single episode of television on its platform and then answers ten questions about the show they just watched as well as three security questions about themselves and if they do this correctly, then the user is paid, rewarded, or credited anywhere a predetermined amount per episode. It is noted that different television series (digital content series) and episodes may have different predetermined amounts that are paid, rewarded, or credited to the user.

The amount that each show will pay, reward, or credit may vary and will be posted on the home page directly above or below the key art or box cover, album art, etc. of the digital content listed on the home page so that users can know how much money they have the potential of earning when they choose to click to access the digital content.

After the user chooses the digital content and then clicks on that show and begins accessing it (via the media player in step 1114), a predetermined number (ten in the current implementation) of products, companies, businesses and or brands will be featured and or integrated into the storyline of the show or in the digital content that the that is being accessed in the current implementation. In other implementations, advertisements will be periodically played that highlight a predetermined number of products.

In some preferred embodiments, once the digital content is entirely finished playing then the end credits will begin to play in the current implementation in step 1116. During the end credits single card credits that feature the name and the logo of the predetermined number of sponsors, brands, businesses, products or companies featured in and or integrated into the digital content will be displayed.

In step 1118, once the digital content has finished playing all the way through to the end of the end credits, then a pop up will appear on the screen that will say something to the effect of: “Answer these 10 questions correctly and you will receive $50 dollars” in the current implementation. In other implementations, the user may be directed to a different website and presented with a verification prompt (e.g. ten questions). In step 1118, ten “A” or “B” questions will appear on the screen with a bubble to click to choose “A” and a bubble to click to choose “B”. The questions will always be about the products, brands, businesses or companies that are featured in and or are integrated into the digital content.

The questions may look like:

“Did the character of “Mars”, in episode 1, that you just watched, wear Nike shoes or did he wear Adidas?”

“Did the character of “Mars”, in episode 2, that you just watched, drive a Cadillac Escalade or did he drive a Lincoln Navigator?”

“Did the character of “Tommy”, in episode 1, that you just watched, order a Monster Energy Drink or did he order a Red Bull?”

The user will click on the answers that they think are correct and when they chose correctly the “A” or “B” bubble will turn green. If they answer incorrectly the “A” or “B” bubble will turn red. If they answer incorrectly the user only has to change his or her answer back to the only other remaining answer left and they will then get the answer right and that letter and bubble will turn green. There should be no way for the user to ever get any of the questions wrong before they submit their answers in the current implementation. In other implementations, the reward may be reduced or eliminated for incorrect answers. In yet other implementations, a reward pot may be added to for incorrect answers and given to a user who has all correct answers.

Through both back-end analytics collected by the SELFMADE server 102 and through blockchain technology (which adds security), user activities are tracked. This activity will be tied to a respective user account and to the IP address where the media play resides. The at least a portion of the collected analytics are then shared with the product seller in step 1120. It is important to note that users may stop and start, pause and rewind the digital content (e.g. an episode of television streamed) as they watch it but they will NOT be able to fast forward through any of the episodes unless or until they have already watched that episode in its ENTIRETY in the current implementation. In other implementations, advertisements may be restricted in such a manner as to require them to be presented in their entirety and at a normal rate.

When all ten questions have been answered correctly and when all ten correctly answered bubbles are green then the user may click a button called “submit.” Once the user clicks “submit” and thus submits a perfectly correct ten-question survey, a pop up will appear that says something to the effect of: “Congratulations! You have answered all ten questions correctly! Simply verify that this is really you and receive $50!” Then three security questions will pop up on the screen, which must be answered correctly in order to receive payment. These three security questions will be selected randomly from the list of the 10 security questions that were filled out by the user when creating their account. This process ensures that the security questions will be different every time they are asked. This approach is something unique and valuable and something that no other company or platform in the world is currently providing.

Verification to a brand like Nike that someone actually watched their ad, interacted with their brand, chose it in a questionnaire over and above their direct competitor, identified themselves by giving verified consent to Nike to let them have their private contact information and to agree to let Nike continue to market to them in the future, pay them and send them coupons for their product.

Once the security questions are all answered correctly verifying that the user, whose account it is, and whose IP address it is, has answered all three questions that only he or she would know and who subsequently has successfully answered all of the questions pertaining to the products, brands, businesses, and companies featured in and or integrated into the show, then the bank or coupon reward is issued in step 1122. A pop up appears in the current implementation that says something to the effect of “Congratulations! You just earned $50! Do you want to put it in your bank and continue watching or do you want to spend it now?” in step 224.

At this time there should be a button that says “bank” on the screen and a button that says “spend.” If the user elects to click on the “bank” button, then the screen will take them back to their account page that they set up when they first signed up and in their account they will have $50 and 10 coupons for the 10 products, businesses, brands or companies that they just interacted with.

Examples of coupons may be:

“Buy one six-pack of Monster Energy Drink gets one free.”

“50% off a pair of Nike shoes.”

“$1000 off the MSRP of a new Cadillac Escalade or any GM product.”

As the user reviews their account there will be a countdown of a predetermined number of seconds (10 in the current implementation) to begin watching the next episode of the show they just watched, unless of course it is the last show in the series in which case the 10 second countdown will take the user back to the “home” page where they may elect to begin watching another series. There is a pause button if the user wishes to pause the countdown to review their account more thoroughly. The “home” button will be present and allows the user to go back to the “home” page to consider accessing different digital content should they elect.

Should the user elect to click the “spend” button then the screen will change and they will be taken to the “spend reward” step 1124 page, referred to as the MALL. The MALL is the web page that lists all of the places that the user can spend their rewards accumulated in their bank and/or it will list all of the places that the user can convert their rewards into real cash.

For example, The MALL might have an icon for Apple Pay, PAYPAL, VENMO, ZELLE, LIBER, POKERSTARS, The NIKE Store, MONEY LION, POSTMATES, GRUBHUB, LYFT, CAPITAL ONE, CHASE, WELLS FARGO, AMAZON and many, many more. During step 224, the user can spend the money they generated and accumulated in their bank account, they can put money on accounts that they have with other companies and vendors or get cash through any one of many options made available to them.

It will be understood and is appreciated by persons skilled in the art, that one or more processes, sub-processes, or process steps described in connection with FIG. 11 may be performed by hardware and/or software (machine-readable instructions). If the approach is performed by software, the software may reside in software memory in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer-readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in computer memory.

The foregoing detailed description of one or more embodiments of the approach with the associated example implementations have been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A method for advertising in digital media, comprising:
creating an account using a digital device;
selecting digital media, where the digital media has at least one product placement;
playing the digital media in a media player on the digital device;
verifying with a test to identify the product that was placed in the digital content that made up the digital media;
verifying a user associated with the account; and
issuing a reward for successful completion of the test and verification of the user, where data from the reward and user are collected and provided to the entity that placed the at least one product placement.

2. The method for advertising in digital media of claim 1, where issuing the reward includes issuing a coupon associated with the at least one product placement.

3. The method for advertising in digital media of claim 2, where issuing the reward further includes crediting a user's account.

4. The method for advertising in digital media of claim 3, where the account is a cryptocurrency account tracked with a blockchain.

5. The method for advertising in digital media of claim 1, where issuing a reward includes crediting a user's account.

6. The method for advertising in digital media of claim 5, where the account is a cryptocurrency account.

7. The method for advertising in digital media of claim 1 where the verifying with a test further includes displaying a digital image from the digital media that depicts the at least one product placement and provide at least two choices to identify a product in the at least one product placement.

8. The method for advertising in digital media of claim 1, where selecting the digital media includes paying for the selected digital media.

9. The method for advertising in digital media of claim 8, where paying for the selected digital media further includes charging a credit card.

10. The method for advertising in digital media of claim 8, where paying for the selected digital media further includes charging an account that contains rewards.

11. The method for advertising in digital media of claim 1, where playing the selected digital media on the media player, where the selected digital media is decrypted at the media player.

12. The method for advertising in digital media of claim 1 where playing the selected digital media on the media player, includes the digital media being streamed to the media player.

13. A system of advertising in digital media, comprising:
a processor in a digital device that is used to create an account for access to the digital media;
a digital media selected with the using the account accessed by the digital device, where the digital media has at least one product placement and a purchase of the digital media occurs;
a test is given on the digital device after completing of the digital media being played to verify the product that was placed in the digital content was viewed; and
a reward issued for successful completion of the test and verification of a user, where data from the reward and user are collected and provided to the entity that placed the at least one product placement.

14. The system of advertising in digital media of claim 13, where the reward includes a coupon associated with the at least one product placement being issued.

15. The system of advertising in digital media of claim 14, where the reward further includes a user's account being credited.

16. The system of advertising in digital media of claim 15, where the account is a cryptocurrency account tracked with a blockchain.

17. The system of advertising in digital media of claim 13, where the reward further includes a user's account being credited.

18. The system of advertising in digital media of claim 17, where the account is a cryptocurrency account tracked with a blockchain.

19. The method for advertising in digital media of claim 13 where the verifying with a test further includes displaying a digital image from the digital media that depicts the at least one product placement and provide at least two choices to identify a product in the at least one product placement.

20. The system of advertising in digital media of claim 13, where the digital media includes paying for the selected digital media before it is played by the media player.

21. The method for advertising in digital media of claim 13 where the selected digital media is streamed to the media player.
